(19) United States
(12) Patent Application Publication
(10) Pub. No.: US 2016/0342887 A1
(43) Pub. Date: Nov. 24, 2016

(54) SCALABLE NEURAL NETWORK SYSTEM

(71) Applicant: minds.ai inc., Santa Cruz, CA (US)

(72) Inventors: Tijmen TIELEMAN, Bilthoven (NL); Sumit SANYAL, Santa Cruz, CA (US); Theodore MERRILL, Santa Cruz, CA (US); Anil HEBBAR, Bangalore (IN)

(21) Appl. No.: 15/160,542

(22) Filed: May 20, 2016

Related U.S. Application Data
(60) Provisional application No. 62/164,645, filed on May 21, 2015.

(51) Int. Cl. G06N 3/04; G06N 99/00; G06N 3/08

(52) U.S. Cl. CPC G06N 3/04; G06N 3/08; G06N 99/005

(57) ABSTRACT

A scalable neural network system may include a root processor and a plurality of neural network processors with a tree of synchronizing sub-systems connecting them together. Each synchronization sub-system may connect one parent to a plurality of children. Furthermore, each of the synchronizing sub-systems may simultaneously distribute weight updates from the root processor to the plurality of neural network processors, while statistically combining corresponding weight gradients from its children into single statistical weight gradients. A generalized network of sensor-controllers may have a similar structure.

### CROSS-REFERENCE TO RELATED APPLICATION

This application is a non-provisional application claiming priority to U.S. Provisional Patent Application No. 62/164,645, filed on May 21, 2015, and incorporated by reference herein.

### FIELD

Various aspects of the present disclosure may pertain to various forms of neural network interconnection for efficient training.

### BACKGROUND

Due to recent optimizations, neural networks may be favored as a solution for adaptive learning-based recognition systems. They may currently be used in many applications, including, for example, intelligent web browsers, drug searching, and identity recognition by face or voice.

Fully-connected neural networks may consist of a plurality of nodes, where each node may process the same plurality of input values and produce an output, according to some function of its input values. The functions may be non-linear, and the input values may be either primary inputs or outputs from internal nodes. Many current applications may use partially- or fully-connected neural networks, e.g., as shown in FIG. 1. Fully-connected neural networks may consist of a plurality of input values 10, all of which may be fed into a plurality of input nodes 11, where each input value of each input node may be multiplied by a respective weight 14. A function, such as a normalized sum of these weighted inputs, may outputted from the input nodes 11 and may be fed to all nodes in the next layer of “hidden” nodes 12, all of which may subsequently feed the next layer of “hidden” nodes 16. This process may continue until each node in a layer of “hidden” nodes 16 may feed a plurality of output nodes 13, whose output values 15 may indicate a result of some pattern recognition, for example.

Multi-processor systems or array processor systems, such as graphic processing units (GPUs), may perform the neural network computations on one input pattern at a time. Alternatively, special purpose hardware, such as the triangular scalable neural array processor described by Pechanek et al. in U.S. Pat. No. 5,509,106, granted Apr. 16, 1996, may also be used.

These approaches may require large amounts of fast memory to hold the large number of weights necessary to perform the computations. Alternatively, in a “batch” mode, many input patterns may be processed in parallel on the same neural network, thereby allowing the weights to be used across many input patterns. Typically, batch mode may be used when learning, which may require iterative perturbation of the neural network and corresponding iterative application of large sets of input patterns to the perturbed neural network. Furthermore, each perturbation of the neural network may consist of a combination of error back-propagation to generate gradients for the neural network weights and cumulating the gradients over the sets of input patterns to generate a set of updates for the weights.

As the training and verification sets grow, the computation time for each perturbation grows, significantly lengthening the time to train a neural network. To speed up the neural network computation, Merrill et al. describe spreading the computations across many heterogeneous combinations of processors in U.S. patent application Ser. No. 14/713,529, filed May 15, 2015, and incorporated herein by reference. Unfortunately, as the number of processors grows, the communication of the weight gradients and updates may limit the resulting performance improvement. As such, it may be desirable to create a communication architecture that scales with the number of processors.

### SUMMARY OF VARIOUS ASPECTS OF THE DISCLOSURE

Various aspects of the present disclosure may include scalable structures for communicating neural network weight gradients and updates between a root processor and a large plurality of neural network workers (NNWs), each of which may contain one or more processors performing one or more pattern recognitions (or other tasks for which neural networks may be appropriate; the discussion here refers to “pattern recognitions,” but it is contemplated that the invention is not thus limited) and corresponding back-propagations on the same neural network, in a scalable neural network system (SNNS).

In one aspect, the communication structure may consist of a plurality of synchronizing sub-systems (SSS), which may each be connected to one parent and a plurality of children in a multi-level tree structure connecting the NNWs to the root processor of the SNNS.

In another aspect, each of the SSS units may broadcast packets from a single source to a plurality of targets, and may combine the contents of a packet from each of the plurality of targets into a single resulting equivalent-sized packet to send to the source.

Other aspects may include sending and receiving data between the parent and children of each SSS unit on either bidirectional buses or pairs of unidirectional buses, compressing and decompressing the packet data in the SSS unit, using buffer memory in the SSS unit to synchronize the flow of data, and/or managing the number of children being used by controlling the flow of data through the SSS units.

The NNWs may be either atomic workers (AWs) performing a single pattern recognition and corresponding back-propagation on a single neural network or may be composite workers (CWs) performing many pattern recognitions on a single neural network in a batch fashion. These composite workers may consist of batch neural network processors (BNNPs) or any combination of SSS units and AWs or BNNPs.

The compression may, like pulse code modulation, be reduced to as little as strings of single bits of data that may correspond to increments of the gradient and increments of weight updates, where each of the gradient increments may be different from each of the NNPs and for each of the weights.

Combining the data may consist of summing the data from each of the children below the SSS unit, or may consist of performing other statistical functions, such as means, variances, and/or higher-order statistical moments, and which may include time or data dependent growth and/or decay functions.

It is also contemplated that the SSS units may be employed to continuously gather and generate observational statistics while continuously distributing control information, and it is further contemplated that observational and control information may be locally adjusted at each SSS unit.

Various aspects of the disclosed subject matter may be implemented in hardware, software, firmware, or combinations thereof. Implementations may include a computer-readable medium that may store executable instructions that may result in the execution of various operations that implement various aspects of this disclosure.

### BRIEF DESCRIPTION OF THE DRAWINGS

Embodiments of the invention will now be described in connection with the attached drawings, in which:

FIG. 1 is a diagram of an example of a multi-layer fully-connected neural network,

FIG. 2 is a diagram of an example of scalable neural network system (SNNS), according to an aspect of this disclosure, and

FIGS. 3A and 3B are diagrams of examples of one synchronizing sub-system (SSS) unit shown in FIG. 2, according to an aspect of this disclosure.

### DETAILED DESCRIPTION OF VARIOUS ASPECTS OF THIS DISCLOSURE

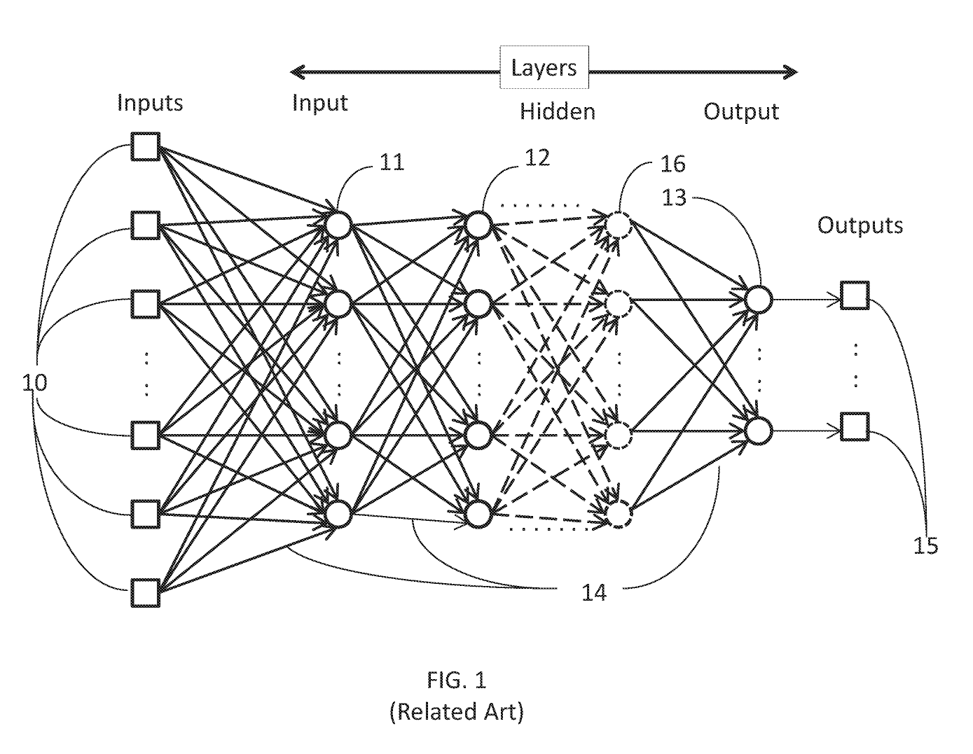

Various aspects of this disclosure are now described with reference to FIGS. 1-3, it being appreciated that the figures illustrate various aspects of the subject matter and may not be to scale or to measure.

In one aspect of this disclosure, the communication structure within a SNNS may consist of a plurality of synchronizing sub-systems (SSS), which may each be connected to one parent and a plurality of children in a multi-level tree structure connecting the AWs or CWs to the root processor.

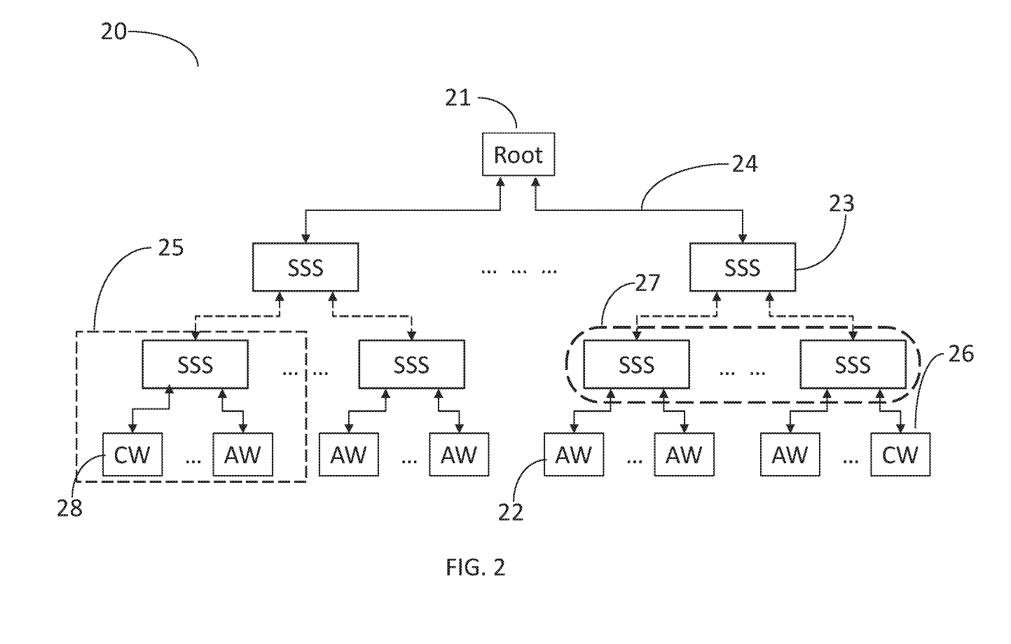

Reference is now made to FIG. 2, a diagram of an example of an SNNS architecture 20 in which multiple point-to-point high-speed bidirectional or paired unidirectional buses 24, such as, but not limited to, gigabit Ethernet or Infiniband or other suitably high-speed buses, may connect the root processor 21 to a plurality of AWs 22 or CWs 25 and 26 through one or more layers of SSS units 23. Each of the SSS units 23 may broadcast packets from a single source, e.g., root processor 21, to a plurality of targets, e.g., SSS units 27, and may, in an opposite direction, combine the contents of a packet from each of the plurality of targets 27 into a single resulting equivalent-sized packet to send to the source 21. An AW 22 may perform a single pattern recognition and corresponding back-propagation on a single neural network. A CW 26 may perform many pattern recognitions on a single neural network in a batch fashion, such as may be done in a BNNP. Alternatively, a CW 25 may consist of or any combination of SSS units and AWs, BNNPs or other CWs 28.

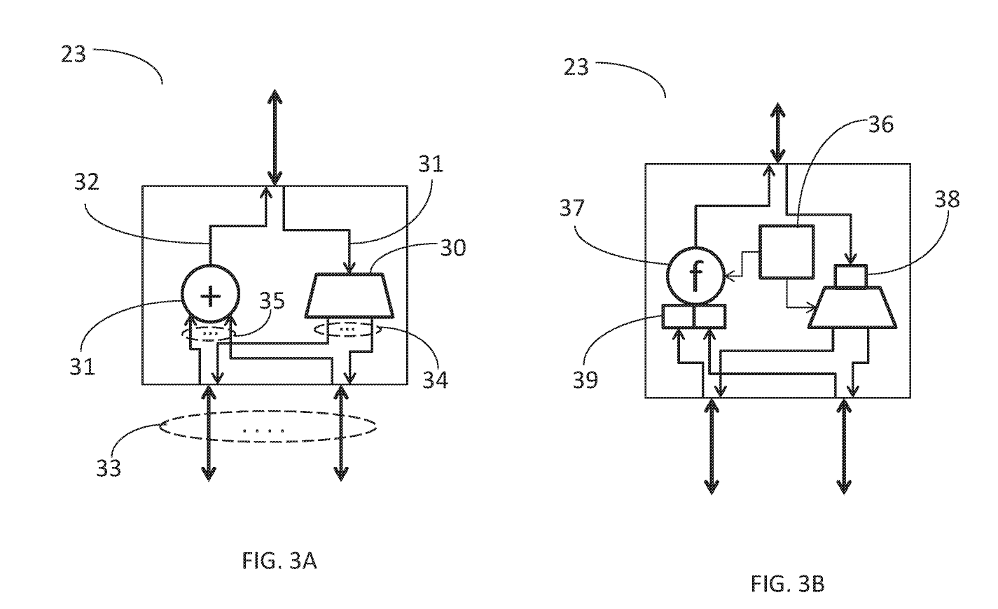

In another aspect, at a system level, in a manner similar to Pechanek's adder tree (108 in FIG. 4B of Pechanek), within a NNW, as described in U.S. Pat. No. 5,509,106, cited above, each SSS unit may pass to a respective parent, a sum of the corresponding gradients of the weights they receive from their children, and may distribute, from the parent, weight updates down to their children. Reference is now made to FIG. 3A, a diagram of an example of one SSS unit 23, according to an aspect of this disclosure. The packet data, may be received from the parent and may be passed via a unidirectional bus 31 to a distributer 30, which may adjust the weight data for each of the plurality of children, and may distribute the adjusted weight data via another set of unidirectional buses 34 to the buses 33. Similarly, the packet data, which may consist of gradient data for the weights, from the plurality of children may be received by the SSS unit, via buses 33, and may be passed, via unidirectional buses 35, to an N-port adder 31, which may scale and add the corresponding gradients together, which may thus produce a packet of similar size to the original packets received from the children.

Reference is now made to FIG. 3B, another diagram of an example of one SSS unit 23, according to an aspect of this disclosure. In this aspect of the disclosure, the SSS unit 23 may also contain first-in first-out (FIFO) memories 38 and 39 for synchronizing the data being distributed and being combined respectively. Furthermore, combining the data in block 37 may consist of summing the data from each of the children below the SSS unit, or may consist of performing other statistical functions such as means, variances, and/or higher-order statistical moments, and which may include time or data dependent growth and/or decay functions.

In another aspect of the current disclosure, the data may be combined and compressed by normalizing, scaling or reducing the precision of the results. Similarly, the data may be adjusted to reflect the scale or precision of each of the children before the data is distributed to the children.

During the iterative process of forward pattern recognition followed by back-propagation of error signals, as the training reaches either a local or global minimum, the gradients and the resulting updates may become incrementally smaller. As such, the compression may, like pulse code modulation, reduce the word size of the resulting gradients and weights, which may thereby reduce the communication time required for each iteration. The control logic 36 may receive word size adjustments from either the root processor or from each of the plurality of the children. In either case, adjustments to scale and/or word size may be performed prior to combining the data for transmission to the parent or subsequent to distribution for each of the children.

In another aspect of the current disclosure, the control logic 36 may, via commands from the root processor, turn on or turn off one or more of its children, by passing an adjusted command on to the respective children and correspondingly adjusting the computation to combine the resulting data from the children.

In yet another aspect of the current disclosure, the control logic 36 may synchronize the packets received from the children by storing the early packets of gradients and, if necessary, stalling one or more of the respective children until the corresponding gradients have been received from all the children, which may then be combined and transmitted to the parent.

It may be noted here that all the AWs, BNNPs and CWs may have separate local memories, which may initially contain the same neural network with the same weights. It is further contemplated that the combining of a current cycle's gradients may coincide with a distribution of a next cycle's weight updates, and that if the gradients take too long to collect, updates may be distributed, thereby beginning the processing of the next cycle, before all of the current cycle's gradients have been combined, thereby varying the weights between the different NNWs. As such the root processor may choose to stall all subsequent iterations until all the NNWs have been re-synchronized.

Furthermore, the root processor may choose to reorder the weights into categories, e.g., from largest to smallest changing weights and, thereafter, may drop one or more of the weight categories on each iteration.

When combined, these techniques may maximize the utilization of the AWs and CWs, by minimizing the communication overhead in the neural network system, thereby making it a more scalable neural network system.

Lastly, in yet another aspect of the current disclosure, the SSS units may be employed between a root processor and a plurality of continuous sensor-controller units to continuously gather and generate observational statistics while continuously distributing control information, and it is further contemplated that the observational and control information may be locally adjusted at each SSS unit.

It will be appreciated by persons skilled in the art that the present invention is not limited by what has been particularly shown and described hereinabove. Rather the scope of the present invention includes both combinations and sub-combinations of various features described hereinabove as well as modifications and variations which would occur to persons skilled in the art upon reading the foregoing description and which are not in the prior art.

What is claimed is:

1. A neural network system, including:
a root processor;
one or more synchronizing sub-systems (SSSs), bidirectionally coupled to the root processor; and
a plurality of neural network processors (NNPs), wherein a respective one of the plurality of NNPs is bidirectionally coupled to one of the one or more SSSs.

2. The neural network system of claim 1, wherein at least one of the plurality of NNPs is an atomic worker (AW).

3. The neural network system of claim 1, wherein at least one of the plurality of NNPs is a composite worker (CW).

4. The neural network system of claim 1, wherein at least one of the plurality of NNPs is a batch neural network processor.

5. The neural network system of claim 1, wherein the one or more SSSs include at least two SSSs arranged in at least two hierarchical layers.

6. The neural network system of claim 1, wherein at least one SSS of the one or more SSSs comprises:
a distributer configured to distribute information to one or more NNPs coupled to the at least one SSS; and
a combiner configured to receive and combine information from the one or more NNPs coupled to the at least one SSS.

7. The neural network system of claim 6, wherein the at least one SSS further comprises:
control logic coupled to the root processor and coupled to control at least one of the combiner or the distributer.

8. The neural network system of claim 6, wherein the at least one SSS further comprises at least one memory coupled to the combiner, the distributer, or both the combiner and the distributer.

9. The neural network system of claim 8, wherein the at least one SSS further comprises:
control logic coupled to the root processor and coupled to control at least one of the combiner or the distributer or the at least one memory.

10. The neural network system of claim 1, wherein the one or more SSSs are configured to receive and distribute weight information to the plurality of NNPs.

11. The neural network system of claim 1, wherein the one or more SSSs are configured to receive and combine weight gradient information from the plurality of NNPs.

12. A synchronizing sub-system (SSS) of a neural network system, the SSS configured to be coupled between a root processor and a plurality of neural network processors (NNPs), the SSS including:
a distributer configured to distribute information to one or more NNPs coupled to the at least one SSS; and
a combiner configured to receive and combine information from the one or more NNPs coupled to the at least one SSS.

13. The SSS of claim 12, further including:
control logic coupled to the root processor and coupled to control at least one of the combiner or the distributer.

14. The SSS of claim 12, further including:
at least one memory coupled to the combiner, the distributer, or both the combiner and the distributer.

15. The SSS of claim 14, further including:
control logic coupled to the root processor and coupled to control at least one of the combiner or the distributer or the at least one memory.

16. The SSS of claim 12, wherein the SSS is configured to receive and distribute weight information to the plurality of NNPs.

17. The SSS of claim 12, wherein the SSS is configured to receive and combine weight gradient information from the plurality of NNPs.

18. A method of operating a neural network, the method including:
coupling a root processor with a plurality of neural network processors (NNPs) through at least one intermediate processing sub-system;
passing information bi-directionally between the root processor and the at least one intermediate processing sub-system; and
passing information bi-directionally between the at least one intermediate processing sub-system and the plurality of NNPs.

19. The method of claim 18, wherein passing information bi-directionally between the root processor and the at least one intermediate processing sub-system includes performing, by the at least one intermediate processing sub-system, compression, decompression, or both, of information being passed.

20. The method of claim 18, wherein passing information bi-directionally between the at least one intermediate processing sub-system and the plurality of NNPs includes performing, by the at least one intermediate processing sub-system, compression, decompression, or both, of information being passed.

21. The method of claim 18, further including performing, by the at least one intermediate processing sub-system, synchronization of data flow in at least one direction between the root processor and the plurality of NNPs.

22. The method of claim 21, wherein the synchronization of data flow includes storing data in a memory of the intermediate processing sub-system.

23. The method of claim 18, further including controlling one or more of the plurality of NNPs to be turned off, in response to a command from the root processor.

24. The method of claim 23, wherein the controlling comprises:
receiving the command at the intermediate processing sub-system;
adjusting the command at the intermediate processing sub-system to obtain an adjusted command; and
passing the adjusted command from the intermediate processing sub-system to at least one of the plurality of NNPs.

25. The method of claim 18, wherein the passing information bi-directionally between the root processor and the at least one intermediate processing sub-system and the passing information bi-directionally between the at least one intermediate processing sub-system and the plurality of NNPs together comprise:
receiving, at the at least one intermediate processing sub-system, information from the root processor and distributing, by the at least one intermediate processing sub-system, corresponding information to the plurality of NNPs; and
receiving, at the at least one intermediate processing sub-system, information from the plurality of NNPs, and combining, by the at least one intermediate processing sub-system, at least a portion of the information received from the plurality of NNPs, prior to forwarding corresponding information, in combined form, to the root processor.

26. The method of claim 25, wherein the information received from the root processor and distributed to the plurality of NNPs comprises neural network weight information.

27. The method of claim 25, wherein the information received from the plurality of NNPs and combined at the at least one intermediate processing sub-system comprises neural network weight gradient information.

28. A method of operating a synchronizing sub-system (SSS) of a neural network system, the SSS configured to be coupled between a root processor and a plurality of neural network processors (NNPs), the method including:
communicating information bi-directionally with the root processor; and
communicating information bi-directionally with the plurality of NNPs.

29. The method of claim 28, further including:
performing compression, decompression, or both, on information being communicated between the SSS and the root processor or between the SSS and the plurality of NNPs or both.

30. The method of claim 28, further including synchronizing data flow in at least one direction between the root processor and the plurality of NNPs.

31. The method of claim 30, wherein the synchronizing data flow comprises storing data in a memory of the SSS.

32. The method of claim 28, further including controlling one or more of the plurality of NNPs to be turned off, in response to a command from the root processor.

33. The method of claim 32, wherein the controlling comprises:
receiving the command from the root processor;
adjusting the command to obtain an adjusted command; and
passing the adjusted command to at least one of the plurality of NNPs.

34. The method of claim 28, wherein the communicating information bi-directionally with the root processor and the communicating information bi-directionally with the plurality of NNPs together comprise:
receiving information from the root processor and distributing corresponding information to the plurality of NNPs; and
receiving information from the plurality of NNPs, and combining at least a portion of the information received from the plurality of NNPs, prior to forwarding corresponding information, in combined form, to the root processor.

35. The method of claim 34, wherein the information received from the root processor and distributed to the plurality of NNPs comprises neural network weight information.

36. The method of claim 34, wherein the information received from the plurality of NNPs and combined comprises neural network weight gradient information.

37. A memory medium containing executable instructions configured to cause one or more processors to implement the method according to claim 18.

38. A neural network system including:
the memory medium according to claim 37; and
one or more processors coupled to the memory medium to enable the one or more processors to execute the executable instructions contained in the memory medium.

39. A memory medium containing executable instructions configured to cause one or more processors to implement the method according to claim 28.

40. A neural network system including:
the memory medium according to claims 39; and
one or more processors coupled to the memory medium according to claim 33 to enable the one or more processors to execute the executable instructions contained in the memory medium.
